(19) United States
(12) Patent Application Publication
(10) Pub. No.: US 2007/0079520 A1
(43) Pub. Date: Apr. 12, 2007

(54) TAPE MEASURE AND METHOD OF MANUFACTURE

(76) Inventors: Steven R. Levine, Mooresville, NC (US); James Alan Weir, Cornelius, NC (US); Hamilton Sean Micheal Whitney, Troutman, NC (US)

Correspondence Address: MOORE & VAN ALLEN PLLC, P.O. BOX 13706, Research Triangle Park, NC, 27709, US

(21) Appl. No.: 11/163,199

(22) Filed: Oct. 10, 2005

(51) Int. Cl. G01B 3/10

(52) U.S. Cl. 33/770

(57) ABSTRACT

A tape measure blade having improved wear characteristics, a tape measure utilizing such a blade, and a method of manufacturing such a blade are provided. A clear film made of polyester, nylon or other flexible, strong and relatively thin material is provided with the measurement indicia, markings or other material printed on one side thereof. The film is attached to the blade with the printed side contacting and secured to the blade such that the side of the film without printing is the side of the film exposed to the environment. Because the film is transparent the printed indicia are visible through the film.

### BACKGROUND

This invention relates generally to tape measures and, more particularly, to a tape measure blade having an improved construction and a method for manufacturing the tape measure blade.

Tape measures typically consist of a flexible tape or blade that is wound on a reel within a housing. The blade is stored in the housing in a wound state and it is unwound and extended from the housing to measure linear distances. The blade can be rewound back into the housing either manually, such as by rotating an external crank, or automatically, such as by use of an internal spring. One typical blade consists of a thin steel strip having measurement indicia printed on a surface thereof such that when the blade is extended from the housing a user can measure linear distances by reading the indicia.

A problem with known blade designs is that over time the printed material wears off of the blade from use. As will be understood tape measures are subjected to relatively harsh conditions where they are used outdoors in all types of weather and under abrasive conditions on construction sites and the like. Moreover, the design of tape measures adds to the wear on the printed material. The repetitive winding and unwinding of the blade causes the printed material on the blade to contact and wear against any surface it contacts. Also, as the blade is retracted it has a tendency to “whip” as the blade enters the housing. This is especially true with automatic tape measures where the spring force applied to the blade causes the blade to accelerate as it retracts into the housing. The whipping of the tape measure blade against the housing further increases the wear of the printed material.

As the printed material wears off the blade, reading the indicia may become difficult or impossible leading to inaccuracies in measurement and unacceptable performance of the tape measure. Because the printed material may wear away before the other structural elements of the tape measure fail, the wear can be a source of frustration for the end user and may present an inaccurate indication of the overall quality of the tape measure.

Thus, an improved tape measure having a blade with improved wear characteristics and a method for manufacturing such a blade is desired.

### SUMMARY

The invention comprises a tape measure blade having improved wear characteristics, a tape measure utilizing such a blade, an a method of manufacturing such a blade. The blade of the invention includes a thin blade that is flexible enough to be wound on a reel in a tape measure housing. The blade may be formed as is known in the art to have a transverse cross-sectional shape that increases the rigidity of the blade and allows it to extend unsupported from the housing. A clear film made of polyester, nylon or other flexible, strong and relatively thin material is provided with the measurement indicia printed on one side thereof. The film is attached to the blade with the printed side contacting and secured to the blade such that the side of the film without printing is the side of the film exposed to the environment. Because the printed material is on the inner surface of the film, the printing is not in contact with the external environment and will not be worn away during normal use. Because the film is transparent the printed material is visible through the film.

### BRIEF DESCRIPTION OF THE DRAWINGS

FIG. 1 is a perspective view of the tape measure of the invention with the housing opened.

FIG. 2 is a side view of an embodiment of the tape measure of the invention.

FIG. 3 is a side view of an embodiment of the tape measure of the invention showing the internal structure thereof.

FIG. 4 is a partially exploded perspective view of an embodiment of the tape measure blade of the invention.

FIG. 5 is a partially exploded perspective view of another embodiment of the tape measure blade of the invention.

FIG. 6 is a partially exploded perspective view of yet another embodiment of the tape measure blade of the invention.

FIG. 7 is a block diagram illustrating the manufacturing process of the tape measure blade of the invention.

FIG. 8 is a flow chart showing a method of manufacturing the tape measure blade of the invention.

### DETAILED DESCRIPTION OF PREFERRED EMBODIMENTS OF THE INVENTION

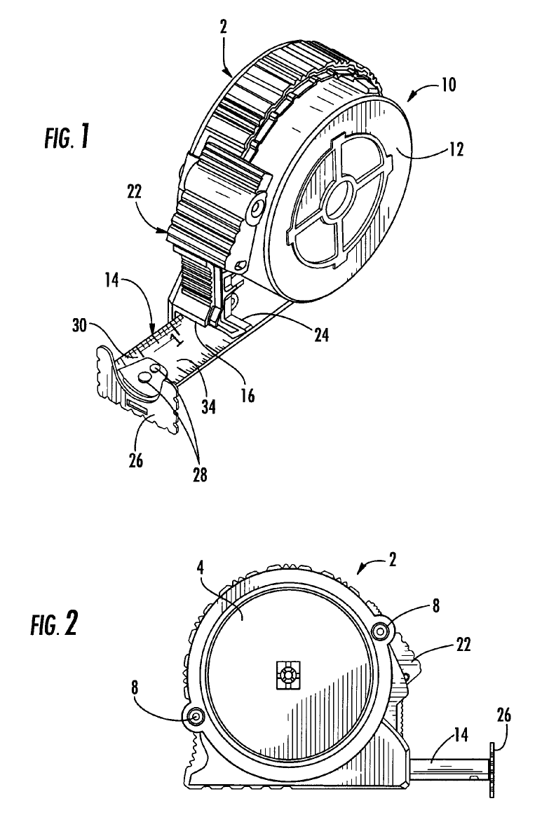

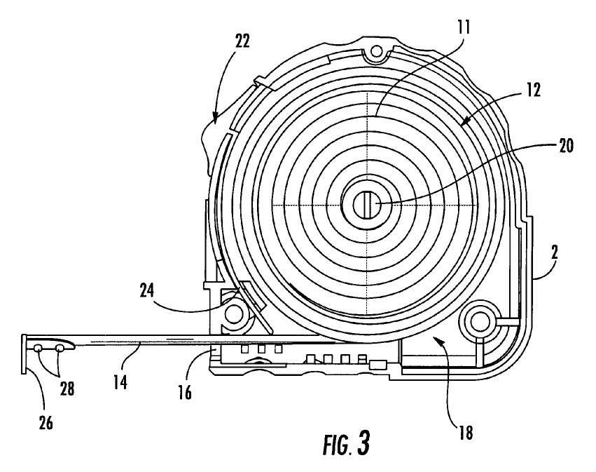

Referring to FIGS. 1, 2 and 3, one embodiment of the tape measure of the invention is shown including a housing 2. The housing 2 may include a first housing portion 4 secured to a second substantially identical housing portion by a fasteners 8 such as screws or rivets to define an interior space 18. Opening 16 is formed in a wall of housing 2 to allow access between interior space 18 and the outside of housing 2. Encased within housing 2 is a hub assembly 10 having a hub 12 that is free to rotate within housing 2 about axle 20. The tape measure blade 14 is wound on hub 12 such that as hub 12 is rotated in a first direction about axle 20, blade 14 can be unwound and extended from housing 2 through opening 16. Reversing rotation of hub 12 rewinds the blade 14 on hub 12 to retract the blade back into the housing 2.

It will be appreciated that unwinding and extending blade 14 is typically done manually while the rewinding of the blade back into the housing is typically done automatically. To automatically rewind the blade, hub assembly 10 includes a spring 11 connected to hub 12 such that extension of the blade 14 deforms the spring to store energy therein whereby when the blade is released the spring releases the stored energy to rotate the hub 12 and rewind the blade. It is also known to provide tape measures in which the blade can be extended automatically using a motor and/or the blade can be retracted manually using an external crank.

To counter the rewind force of the spring and maintain the blade in the extended position a brake 22 is provided. Brake 22 may consist of a sliding member 24 that moves between a first position in which it contacts the blade 14 to trap the blade between member 24 and housing 2 to maintain the blade in an extended position and a second position where the member 24 does not contact the blade 14 such that the blade can be freely extended or retracted.

Blade 14 has one end connected to hub 12 and an opposite end extending from housing 2 and connected to an end hook 26 via fasteners 28 such as rivets. End hook 26 is used to prevent retraction of the blade 14 completely into the housing 2 and to temporarily secure the blade to a surface during use of the tape measure.

Referring to FIG. 4, the blade 14 of the invention includes of a thin strip of steel or other material that is flexible enough to be wound on hub 12 yet strong enough to maintain an effective standout when extended from housing 2. “Standout” is the distance that the blade can extend unsupported from the housing before buckling. To increase blade standout it is known to design blades that have, in the extended position, a curved or other involute transverse profile. The specific material and physical design of the blade can vary from that shown and described herein to meet different blade performance criteria. The strip of steel is formed slightly longer than the desired working length of the tape measure to account for the length of material that is attached to the hub 12 and remains in the housing even when the blade is in its fully extended position.

A film 30 is applied to the upper surface 14a of blade 14. The film 30 is a thin length of transparent, durable and flexible material such as polyester, polyethylene, polyurethane, polypropylene, nylon or the like having a thickness of 0.001 to 0.015 inches. Measurement indicia, other markings and/or other printed material 32 are printed on the inner surface 30a of film 30. The “inner surface” as used herein refers to the surface of the film that contacts and is attached to the blade after the blade is assembled. The “outer surface” refers to the surface 30b of the film 30 that is exposed to the environment in the assembled blade. The measurement indicia may consist of linear units in the metric or English systems or both. The other markings or printed material may consist of branding information, application specific information such as sixteen inch “on center” stud markings or the like.

The film 30 is attached to the blade 14 by an adhesive such that the film is permanently and securely attached to the blade. The film is permanently affixed to said blade such that in normal operation of the blade, the film remains secured to the blade. An adhesive such as silicone or acrylic may be used. In one embodiment the film 30 extends over the entire upper surface 14a of the blade 14 for the entire length and width thereof.

Because the printed material 32 is on the inner surface 30a of the film 30, the unprinted outer surface 30b of the film is exposed such that the thickness of the film protects the printed material 32. In this manner the printing will not degrade or wear from the extension and retraction or use of the blade. Because the film 30 is transparent the printed material 32 is clearly visible to the end user through the film. The printed material 32 is printed on the inner surface of the film in reverse such that the printed material will be in the proper orientation for reading by the end user when viewed through outer surface 30b.

An alternate embodiment of the invention is shown in FIG. 5 and comprises a blade 14, as previously described with respect to FIG. 4 above, having a film 34 with its inner surface 34a secured to the bottom surface 14b of blade 14. Film 34 contains markings, indicia or other printed material 36 on its inner surface 34a as previously described. The film 34 is applied to the bottom surface 14b of blade 14 by adhesive and can be used where it is desired to have markings visible on the bottom side of blade 14. Film 30 may be applied to the top surface of the blade and film 34 may be applied to the bottom surface of the same blade so that markings are visible when viewing both the top and bottom of the blade.

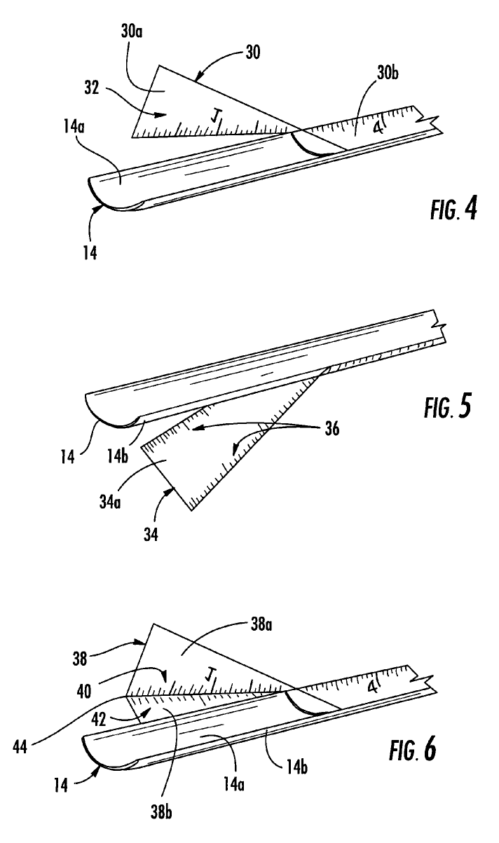

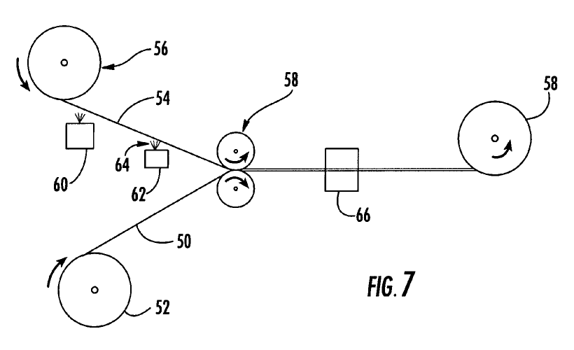

While a separate first film 30 and second film 34 may be used, a single film 38 having both top markings 40 and bottom markings 42 may be used as shown in FIG. 6. Film 38 has a top portion 38a that extends over and is attached to upper surface 14a and a bottom portion 38b that extends over and is attached to bottom surface 14b where film 38 is wrapped around one edge of the blade at fold line 44.

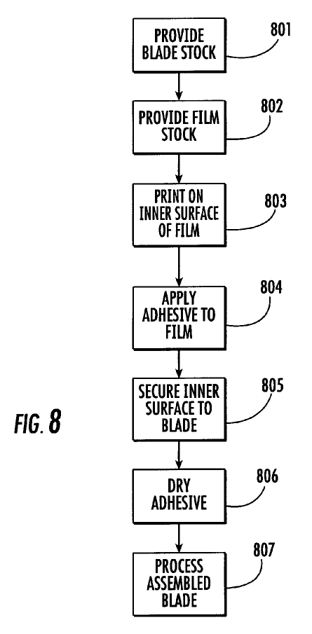

One method of manufacturing the blade of the invention will be described with reference to FIGS. 7 and 8. A supply of blade stock 50 is provided, shown as a wound coil 52 (block 801). The blade stock 50 has been formed to have the extended profile described with respect to FIG. 4 and may be treated to increase strength, painted and otherwise processed to create the final blade configuration. A supply of film stock 54 is also provided, shown as a wound coil 56 (block 802). The blade stock 50 and film stock 54 are pulled through opposed feed rollers 58 that apply pressure to force film stock 54 into contact with blade stock 50. A printer 60 such as a laser jet printer prints the indicia, markings and/or other material on the inner surface of the film stock 54 as it moves past the printer (block 803). An adhesive applicator 62 applies adhesive 64 to the inner surface of the film (block 804). Alternatively, the adhesive may be applied to the blade. As the film stock 54 and blade stock 50 are passed between rollers 58 the inner surface of the film stock is pressed against the blade stock and the film stock is secured to the blade stock by the adhesive 64 (block 805). A drying chamber 66 may be used to dry the adhesive to create the final blade (block 806). The blade stock with the film stock secured thereto is wound onto another coil 58 where it can be cut to the desired length and further processed to create the assembled tape measure (block 807).

Another alternative to the method of manufacture, is to print the indicia and markings in a separate process such that coil 56 has wound thereon preprinted film stock. It is also contemplated that film pretreated with adhesive may be used. If such film is used it would typically be wound on coil 56 with a backing material placed over the adhesive to prevent the layers of film from sticking to one another. The backing material is removed from the film before the film enters the printer. In this embodiment the separate adhesive application step may be omitted. It is further contemplated that if film is to be applied to both sides of the blade, the film may be applied to both sides of the blade in a single process or the process may be repeated for each side of the blade.

Specific embodiments of an invention are disclosed herein. One of ordinary skill in the computing and financial arts will quickly recognize that the invention has other applications in other environments. Many embodiments are possible. The following claims are in no way intended to limit the scope of the invention to the specific embodiments described above.

1. A blade for a tape measure comprising:
a blade made of steel and having a first surface;
a transparent film secured to said first surface, wherein said film is secured to said first surface by adhesive; and
markings on said film and visible through said film.

2. (canceled)

3. The blade of claim 1 wherein said markings are printed on said film.

4. The blade of claim 1 wherein said markings are length indicia.

5. (canceled)

6. The blade of claim 1 wherein said film has an inner surface and an outer surface said inner surface being secured to said first surface and said markings being made on said inner surface.

7. The blade of claim 1 wherein said film extends over substantially the entire first surface.

8. The blade of claim 4 wherein the markings are English units.

9. The blade of claim 4 wherein the markings are metric units.

10. The blade of claim 1 wherein the film is permanently secured to said blade.

11. A tape measure comprising:
a housing for retaining a blade;
a blade made of steel and having a first surface;
a transparent film secured to said first surface, wherein said film is secured to said first surface by adhesive; and
markings on said film and visible through said film.

12. The tape measure of claim 11 wherein the blade can be extended from and retracted into the housing.

13. The tape measure of claim 11 wherein a spring retracts the blade into the housing.

14. The tape measure of claim 11 wherein the blade supports an end hook at one end thereof.

15. A method of making a blade for a tape measure comprising:
providing a blade having a first surface;
securing a transparent film to said first surface using adhesive wherein said film has a second surface and an edge along said first and second surfaces, and said step of securing a transparent film includes applying said film to the first surface and the second surface and wrapping said film around said edge; and
providing markings on said film, said markings being visible through said film.

16. The method of claim 15 further printing said markings on said film.

17. (canceled)

18. The method of claim 15 wherein said film has an inner surface and an outer surface, securing said inner surface to said first surface and providing said markings on said inner surface.

19. The method of claim 15 extending said film over substantially the entire first surface and second surface.

20. The method of claim 15 wherein the step of securing includes applying adhesive to said film to permanently secure the film to the blade.

21. The method of claim 15 wherein said markings include measurement indicia.

22. A tape measure comprising:
a housing for retaining a blade;
a blade having a first surface, a second surface and an edge extending along said first surface and said second surface;
a transparent film secured to said blade, said transparent film having a top portion that extends over and is attached to the first surface and a bottom portion that extends over and is attached to the second surface where said film is wrapped around said edge of the blade; and
markings on said film and visible through said film.
